(19) United States
(12) Patent Application Publication
(10) Pub. No.: US 2025/0061623 A1
(43) Pub. Date: Feb. 20, 2025

(54) WORD GENERATION METHOD, AND APPARATUS, ELECTRONIC DEVICE, AND STORAGE MEDIUM

(71) Applicant: Beijing Zitiao Network Technology Co., Ltd., Beijing (CN)

(72) Inventors: Wei LIU, Beijing (CN); Fangyue LIU, Beijing (CN)

(21) Appl. No.: 18/725,679

(22) PCT Filed: Dec. 26, 2022
(86) PCT No.: PCT/CN2022/141780

§ 371 Date: Jun. 28, 2024

(30) Foreign Application Priority Data
Dec. 29, 2021 (CN) 202111641156.4

(51) Int. Cl. G06T 11/20; G06V 30/18; G06V 30/19; G06V 30/244; G06V 30/28

(52) U.S. Cl. CPC G06T 11/203; G06V 30/1801; G06V 30/19127; G06V 30/19147; G06V 30/1916; G06V 30/19173; G06V 30/245; G06V 30/287

(57) ABSTRACT

The disclosure provides a method and apparatus for generating a word, an electronic device, and a storage medium. The method for generating a word includes: obtaining images corresponding to a word to be processed and a reference word; and inputting the image to be processed into a target font style fusion model to obtain a target word of the word to be processed in a target font style. The target font style is determined based on the target font style fusion model fusing a reference font style of the reference word and a font style to be processed of the word to be processed.

### CROSS-REFERENCE TO RELATED APPLICATION(S)

The disclosure claims the priority to the Chinese Patent Application No. 202111641156.4, filed to the Chinese Patent Office on Dec. 29, 2021, which is incorporated in its entirety herein by reference.

### FIELD

The disclosure relates to the technical field of image processing, and relates to, for instance, method, apparatus, electronic device, and storage medium for generating word.

### BACKGROUND

A style transfer or image translation technology is better at modifying texture of images than modifying structural information of images. However, since a form and a structure of a Chinese word are essential to distinguish a variety of fonts, plenty of bad cases (such as broken strokes, uneven edges, and lost or redundant strokes) are produced in fonts generated in font data style transfer or image translation tasks in the related art. In consequence, a result of font fusion through artificial intelligence (AI) dramatically differs from an actual requirement.

### SUMMARY

The disclosure provides a method and apparatus for generating a word, an electronic device, and a storage medium, so as to generate a word having a font style between two font styles.

In a first aspect, the disclosure provides a method for generating a word. The method includes:
obtaining image to be processed corresponding to a word to be processed and a reference word respectively; and
inputting the image to be processed into a target font style fusion model to obtain a target word of the word to be processed in a target font style.

The target font style is determined based on the font style fusion model fusing a reference font style of the reference word and a font style to be processed of the word to be processed.

In a second aspect, the disclosure further provides an apparatus for generating a word. The apparatus includes:
an image to be processed obtaining module configured to obtain image to be processed corresponding to a word to be processed and a reference word respectively; and
a target word determination module configured to input the image to be processed into a target font style fusion model to obtain a target word of the word to be processed in a target font style.

The target font style is determined based on the font style fusion model fusing a reference font style of the reference word and a font style to be processed of the word to be processed.

In a third aspect, the disclosure further provides an electronic device. The electronic device includes:
one or more processors; and
a memory configured to store one or more programs.

When the one or more programs are executed by the one or more processors, the one or more processors are caused to implement the above method for generating a word.

In a fourth aspect, the disclosure further provides a storage medium including a computer-executable instruction. The computer-executable instruction executes the above method for generating a word when being executed by a processor of a computer.

In a fifth aspect, the disclosure further provides a computer program product. The computer program product includes a computer program hosted by a non-transitory computer-readable medium. The computer program includes a program code configured to execute the above method for generating a word.

### BRIEF DESCRIPTION OF THE DRAWINGS

FIG. 1 is a schematic flow diagram of a method for generating a word according to Example 1 of the disclosure;

FIG. 2 is a schematic diagram of a target font style fusion model according to Example 1 of the disclosure;

FIG. 3 is a schematic diagram of a target font style according to Example 1 of the disclosure;

FIG. 4 is a schematic flow diagram of a method for generating a word according to Example 2 of the disclosure;

FIG. 5 is a schematic structural diagram of an apparatus for generating a word according to Example 3 of the disclosure; and

FIG. 6 is a schematic structural diagram of an electronic device according to Example 4 of the disclosure.

### DETAILED DESCRIPTION OF EMBODIMENTS

Examples of the disclosure will be described below with reference to the accompanying drawings. Although some examples of the disclosure are shown in the accompanying drawings, the disclosure may be implemented in various forms, and the examples are provided for understanding of the disclosure. The drawings and the examples of the disclosure are only for illustrative purposes.

A plurality of steps described in method embodiments of the disclosure may be executed in a different order and/or in parallel. Further, the method embodiments may include additional steps and/or omit execution of the illustrated steps, which do not limit the scope of the disclosure.

The terms “include” and “comprise” used herein and their variations are open-ended, that is, “include but not limited to” and “comprise but not limited to”. The term “based on” means “at least partly based on”. The term “an example” means “at least one example”. The term “another example” means “at least another example”. The term “some examples” means “at least some examples”. Related definitions of other terms will be given in the following description.

Concepts such as “first” and “second” mentioned in the disclosure are only used to distinguish different apparatuses, modules or units, and are not used to limit an order or interdependence of functions executed by the apparatuses, modules or units.

Modification with “a”, “an” or “a plurality of” mentioned in the disclosure is illustrative rather than limitative, and should be understood by those skilled in the art as “one or more” unless stated otherwise in the context.

Names of messages or information exchanged between a plurality of apparatuses in the embodiment of the disclosure are only for illustrative purposes, instead of limiting the scope of the messages or information.

### EXAMPLE 1

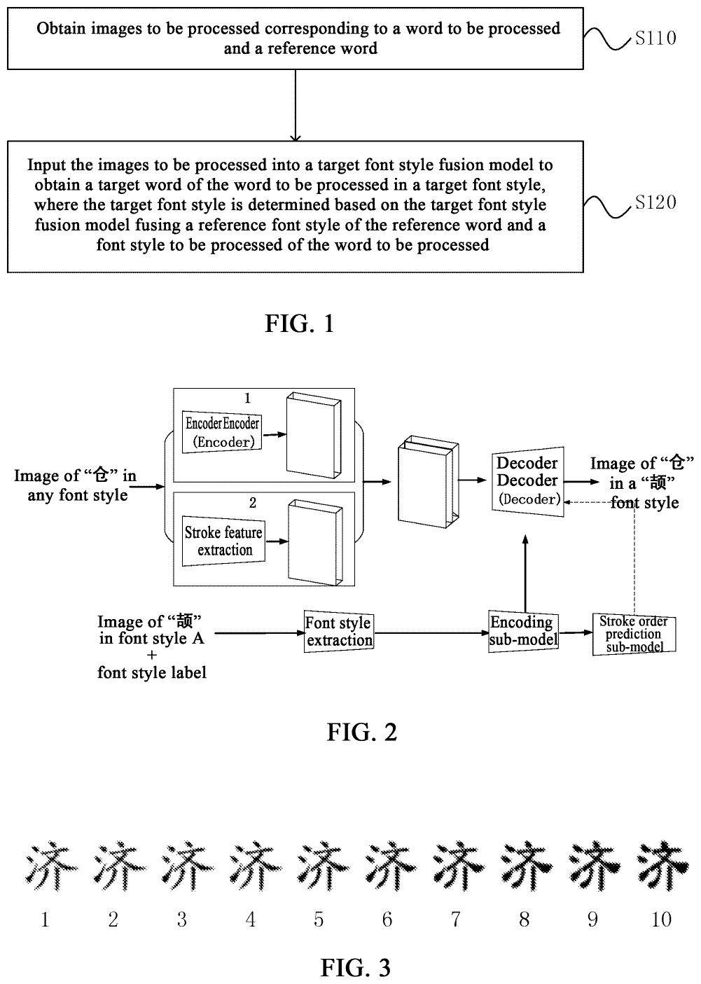

FIG. 1 is a schematic flow diagram of a method for generating a word according to Example 1 of the disclosure. The example is suitable for a case of fusing two font styles of words to obtain a word having any font style between the two font styles. The method may be executed by an apparatus for generating a word. The apparatus may be implemented in a form of software and/or hardware. The hardware may be an electronic device, such as a mobile terminal, a personal computer (PC) terminal, or a server.

Before the technical solution is introduced, an application scene may be illustratively described at first. The technical solution may be applied to a scene of generating a font style between two font styles based on any two font styles obtained. The font styles obtained may be font styles copyrighted, such as a song typeface style or a regular script style in a drop-down list for font style selection, or a font style of a handwritten word of a user, which are not limited herein. That is, the user desires to convert a font style of the word into a font style between any two font styles in the drop-down list for font style selection. That is, a font style desired includes both font style A and font style B, and is not completely consistent with the font style A or the font style B. Based on the solution of the example, a word having a font style between any two font styles may be generated, and the font style of the word generated is a font style between any two font styles based on user input.

As shown in FIG. 1, the method of the example of the disclosure includes the following steps:

S110, image to be processed corresponding to a word to be processed and a reference word are obtained.

The word to be processed may be a word that a user desires to conduct font style conversion on. The word to be processed may be a word selected by the user from a font gallery, or a word written by the user. For instance, after the user writes a word, image recognition is conducted on the word written, and the word recognized is used as the word to be processed. The reference word may be a word having a font style that has to be integrated with a font style of the word to be processed. For instance, styles of the reference word may include font styles copyrighted, such as a regular script style, a clerical script style, a running script style, a cursive script style, a song typeface style, or a handwritten font style of the user. The image to be processed may be an image corresponding to the word to be processed or an image corresponding to the reference word.

The image corresponding to the word to be processed or the image corresponding to the reference word is obtained from a word database, and the image obtained may be used as the image to be processed. Alternatively, the user writes a word by himself/herself, then the word written is photographed, and an image corresponding to the word written by the user may be used as the image to be processed. After the image to be processed is obtained, the word in the image to be processed is recognized, such that font styles and font features of the word to be processed and the reference word may be obtained. The word to be processed and the reference word may have the same or different font styles.

The step that the image to be processed corresponding to the word to be processed and the reference word are obtained includes: the image to be processed corresponding to the word to be processed and the reference word are generated based on the word to be processed and the reference word that are edited in an editing control.

The editing control may be a control configured to input the word to be processed or the reference word. For instance, the editing control may be set in an interface of a font selection system so as to facilitate inputting of the word to be processed or the reference word by the user. After the word to be processed or the reference word is input into the editing control, the word to be processed or the reference word is processed by an image processing module in the font selection system, and the image to be processed corresponding to the word to be processed or the reference word may be obtained.

A word selection system is provided with an editing control. The user may edit the word to be processed and the reference word by means of the editing control, and click yes to determine the word to be processed and the reference word. Then, the word to be processed and the reference word are transmitted to the image processing module in the word selection system, and the image processing module conducts image conversion on the word to be processed or the reference word, such that the image to be processed corresponding to the word to be processed and the reference word are obtained. The word to be processed and the reference word may also be handwritten words of the user. After writing, the handwritten words of the user are photographed to obtain images as the image to be processed.

S120, the image to be processed is input into a target font style fusion model, and a target word of the word to be processed in a target font style is obtained.

The target font style fusion model may be a model of fusing different font styles. The target font style fusion model may be a pre-trained neural network model, and for instance, a convolutional neural network model. A format of input data of the model is an image format, and accordingly, a format of output data is also an image format. The target font style may be any font style between two font styles obtained by fusing font styles of the word to be processed and the reference word. The font styles fused may include a plurality of font styles, any of which may be used as the target font style. The target word may be a word having the target font style.

The image to be processed corresponding to the word to be processed and the image to be processed corresponding to the reference word are input into the target font style fusion model. As shown in FIG. 2, an image to be processed corresponding to a word to be processed “ [symbol] (cang)” and an image to be processed corresponding to a reference word “ [symbol] (jie)” are input into the target font style fusion model. The words in the two images have different font styles. After the two image to be processed are processed based on the target font style fusion model, the image of the word “ [symbol] ” having a font style of the word “ [symbol] ” may be obtained. For instance, the image of the word “ [symbol] ” having the same font style as the word “ [symbol] ” may be obtained, or the image of the word “ [symbol] ” having a font style between the font style of the word to be processed and the font style of the reference word may be obtained. Any font style is used as the target font style, and the target word corresponding to the target font style is obtained.

If the target font style obtained does not match a font style required by the user, the user may use the word having the target font style as the word to be processed, and then fuse the font styles until a font style that the user is satisfied with is obtained.

For instance, font style processing of a word “ [symbol] ” is taken as an instance. With reference to FIG. 3, a plurality of font styles corresponding to the word “ [symbol] ” in the figure are font styles copyrighted, which are only illustrative but not intended to limit copyrights of the font styles. An image to be processed corresponding to a number 1 and an image to be processed corresponding to a number 10 are input into the target font style fusion model, and any font style between two font styles may be obtained. For instance, any font style between a number 2 and a number 9 may be obtained, and any font style may be used as the target font style. For instance, if the target font style obtained is a font style having a number 5, and a font style actually required by the user is a font style having a number 8. That is, the target font style obtained is different from the font style expected by the user. The font styles may be further fused based on the target font style fusion model. For instance, the font styles having the number 5 and the number 10 are used as the image to be processed, input into the target font style fusion model and processed until the target font style consistent with the font style expected by the user is obtained.

To-be-used words of a plurality of words in the target font style are generated based on the target font style fusion model, and a word package is generated based on the to-be-used words.

The word package includes a plurality of to-be-used words, and the to-be-used words are generated based on the target font style fusion model. In order to obtain words having two different font styles, images corresponding to the two words are processed based on the target font style fusion model, and any font style between the two font styles may be obtained. If the font style obtained in this case is consistent with an expectation of the user, the words having the above two font styles are processed based on the target font style fusion model, and the to-be-used words of different words in the corresponding style. A set of all the to-be-used words may be the word package.

In response to detecting that a font style selected from a font style list is the target font style and that the word to be processed is edited, the target word corresponding to the word to be processed is obtained from the word package.

The font style list includes a plurality of to-be-selected font styles, which may be font styles commonly used and font styles copyrighted. For instance, a regular script style, a song typeface style or a clerical script style may be selected from a drop-down list for font style selection. Alternatively, the to-be-selected font styles may be font styles that are different from the existing font styles and obtained by fusing the two font styles based on the target font style fusion model. A display mode of the list may be a drop-down window including a plurality of font styles or an image display window. The user may click to select the target font style based on option information in the list.

The font style list includes existing font styles and further includes font styles generated based on the target font style fusion model. The font style selected by the user from the font style list is used as the target font style. Then, in response to detecting the word to be processed that is edited by the user, a word the same as the word to be processed is obtained from the word package, such that the font style of the word to be processed matches the font style selected by the user.

For instance, the font style selected by the user from the font style list is: font style A after fusion. In response to receiving an input word to be processed “ [symbol] (ke)”, the word “ [symbol] ” may be determined from a word package corresponding to target font style A and displayed as a target word. The technical solution may be applied to office software, and the technical solution is integrated in the office software. Alternatively, the word package is integrated in office software. Alternatively, the target font style fusion model is integrated in application software.

According to the technical solution of the example of the disclosure, the image to be processed corresponding to the word to be processed and the reference word are obtained respectively, such that the font style to be processed and the reference font style are fused based on the target font style fusion model, and any font style between the font styles of the word to be processed and the reference word is obtained. In addition, the font styles may be repeatedly fused according to a requirement of a user until a word having a font style consistent with the requirement of the user is obtained. The image to be processed is input into the target font style fusion model, and the target word of the word to be processed in the target font style is obtained, such that a requirement of a user for converting a font style of the word to be processed into the target font style is satisfied. A problem that a word having a font style between two font styles cannot be generated is solved. The two font styles are fused into any target font style between the two font styles, and a word consistent with the target font style is generated, such that a word corresponding to any font style between the two font styles is generated.

### EXAMPLE 2

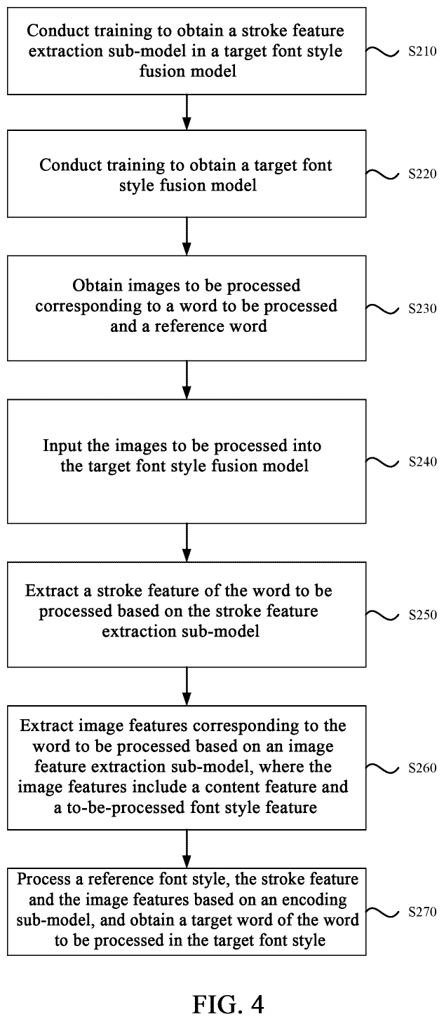

FIG. 4 is a schematic flow diagram of a method for generating a word according to Example 2 of the disclosure. Based on the above example, a target font style fusion model includes a font style extraction sub-model, a stroke feature extraction sub-model, an image feature extraction sub-model, and an encoding sub-model. Before two font styles are fused based on the target font style fusion model, the stroke feature extraction sub-model is pre-trained, such that a to-be-trained font style fusion model may be created based on the stroke feature extraction sub-model, and further the target font style fusion model may be trained. Technical terms the same as or corresponding to the above example are not repeated herein.

As shown in FIG. 4, the method includes:

S210, training is conducted to obtain the stroke feature extraction sub-model in the target font style fusion model.

In the example, the step that training is conducted to obtain the stroke feature extraction sub-model in the target font style fusion model includes: a first training sample set is obtained, where the first training sample set includes a plurality of first training samples, and the first training samples include first images and first stroke vectors corresponding to first training words; and for the plurality of first training samples, a first image of a current first training sample is used as an input parameter of a to-be-trained stroke feature extraction sub-model, a corresponding first stroke vector is used as an output parameter of the to-be-trained stroke feature extraction sub-model, and the to-be-trained stroke feature extraction sub-model is trained to obtain the stroke feature extraction sub-model.

The stroke feature extraction sub-model may be configured to extract a stroke feature of a word. During practical application, in order to improve accuracy of the model, as many training samples as possible are obtained, such that a large number of training samples may be trained based on a training model, and a model parameter may be adjusted. The first training sample set includes the first images and the first stroke vectors corresponding to a plurality of first training words. The first training words may be words trained based on the stroke feature extraction sub-model. Because the model mostly processes images, the first training word may be converted into a corresponding image, that is, the first image before the first training word is input into the model for training. Before the first stroke vector is determined, a reference stroke vector may be created based on a word having a largest number of strokes. For instance, the word having the largest number of strokes mostly has 29 strokes, and accordingly, a vector of order 1*29 may be created. When a stroke vector of each first training word is created, whether the stroke exists in a corresponding position in the vector of the order 1*29 may be determined. If yes, the position is labeled as 1, and if not, the position is labeled as 0.

For instance, determination of a first stroke vector of a word “ [symbol] ” is taken as an instance. Firstly, a vector of order 1*29 is created according to a word having a largest number of stroke features. The vector includes all the stroke features. Stroke features in the word “ [symbol] ” include a “left-falling stroke”, a “right-falling stroke”, a “horizontal turning hook”, and a “vertical curved hook”, and then the first stroke vector corresponding to the word “ [symbol] ” is determined according to a result of whether a corresponding stroke feature exists in a first stroke vector pre-created. For instance, the first stroke vector corresponding to the word “ [symbol] ” may be obtained as {101001010 . . . }. The vector is of the order 1*29. 1 in the vector indicates that a stroke feature corresponding to the word “ [symbol] ” exists in the first stroke vector pre-created. 0 indicates that no stroke feature corresponding to the word “ [symbol] ” exists in the first stroke vector pre-created.

A plurality of to-be-trained words are obtained as the first training samples, each to-be-trained word is converted into the corresponding first image, and meanwhile, a vector corresponding to each word is created as the first stroke vector. In practical application, when stroke feature extraction is conducted on each first training sample based on the stroke feature extraction sub-model, the first image corresponding to the first training word may be used as the input parameter, and the first stroke vector corresponding to the first training word may be used as the output parameter.

Before the stroke feature extraction sub-model is used, the model has to be trained. A large number of first training sample sets are trained, and the stroke feature extraction sub-model is obtained, such that stroke feature extraction is accurately conducted on each input first training word based on a stroke feature extraction model.

S220, training is conducted to obtain the target font style fusion model.

Based on the above content, after the stroke feature extraction sub-model is trained, the to-be-trained font style fusion model is created based on the stroke feature extraction sub-model, and the to-be-trained font style fusion model may be trained after creation is completed.

The created to-be-trained font style fusion model includes: a to-be-trained font style extraction sub-model, the stroke feature extraction sub-model, a to-be-trained image feature extraction sub-model, and a to-be-trained encoding sub-model. With reference to FIG. 2, the image feature extraction sub-model is shown in block 1 in the figure, which is configured to extract an image feature corresponding to a word to be processed. The stroke feature extraction sub-model is shown in block 2, which is configured to extract a stroke feature of the word to be processed. A reference word “ [symbol] ” and a font style label corresponding to the word “ [symbol] ” are input into the font style extraction sub-model (that is, a font style extractor), such that a reference font style of the reference word may be extracted. The encoding sub-model may be configured to encode an extraction result after extracting a font style of the reference word. Then, an encoding result of the font style of the reference word and a stroke feature extraction result of the word to be processed are jointly input into a decoder, such that a word having a font style between font styles of the word to be processed and the reference word may be obtained by means of the decoder. In addition, after the encoding sub-model, a stroke order prediction sub-model is further connected to predict a stroke order of a word input. For instance, any word may be input into the target font style fusion model. With the input word “ [symbol] ” as an instance, stroke order features of the word “ [symbol] ” are a “left-falling stroke”, a “right-falling stroke”, a “horizontal turning hook”, and a “vertical curved hook” respectively. After the word “ [symbol] ” is input into the model, the stroke order features corresponding to the word “ [symbol] ” may be stored in a vector ht separately, and the vector ht={h1,h2, h3, h4} may be obtained according to a stroke order. Then, a stroke order vector obtained is input into a stroke order prediction model, and the stroke order features are trained and analyzed based on a neural network (for instance, a convolutional neural network), such that the stroke order features of the word may be predicted after training of the to-be-trained font style fusion model is completed, and stroke order missing or an incorrect stroke order in an output word result may be avoided.

The step that training is conducted to obtain the target font style fusion model includes: a second training sample set is obtained, where the second training sample set includes a plurality of second training samples, and the second training samples include second training images of second training words, third training images of third training words, and font style labels of the third training words; and the second training words and the third training words have the same or different font styles; for the plurality of second training samples, a current second training sample is input into a to-be-trained font style fusion model, the font style label and the third training image of the third training word are processed based on a to-be-trained font style extraction sub-model, so as to obtain a to-be-fused font style, content feature extraction is conducted on the second training image based on a to-be-trained image feature extraction sub-model, so as to obtain a to-be-fused content feature, stroke feature extraction is conducted on the second training word in the second training image based on the stroke feature extraction sub-model, so as to obtain the stroke feature, and the to-be-fused font style, the to-be-fused content feature and the stroke feature are processed based on a to-be-trained encoding sub-model, so as to obtain an actual output image, where the to-be-trained font style fusion model includes the to-be-trained font style extraction sub-model, the to-be-trained image feature extraction sub-model, and the to-be-trained encoding sub-model; loss processing is conducted on the actual output image and a corresponding theoretical output image according to at least one loss function, a loss value is determined, and at least one model parameter in the to-be-trained font style fusion model is corrected based on the loss value; and convergence of the at least one loss function is set as a training target, and the target font style fusion model is obtained.

The at least one loss function used in the technical solution includes a reconstruction loss function, a stroke order loss function, an adversarial loss function, a triplet loss function, and a style regularization loss function.

A function of each of the loss functions in the model will be introduced as follows:

A first loss function is the reconstruction loss function (Rec Loss). The function is configured to visually constrain whether network output meets expectation. When training is conducted based on image to be processed corresponding to words having two different font styles, a font style between the two font styles may be obtained. If the font style obtained does not satisfy a requirement of a user, a model parameter may be adjusted by means of the reconstruction loss function, such that an output result of the model is more consistent with the requirement of the user.

A second loss function is the stroke order loss function, which may be configured to pre-train a self-designed recurrent neural network (RNN) capable of predicting stroke order information. The number of nodes in the RNN is the largest number of strokes of Chinese words, and predicted features of all the nodes are combined through a connection function, such that a stroke order feature matrix is formed. Before training of a to-be-trained target font style fusion model is completed, an output result of the model may have a problem of an incorrect stroke order or stroke order missing. In this case, the model is continuously adjusted based on the stroke order loss function, and a stroke order result corresponding to an input word may be obtained. Alternatively, the model is trained and adjusted, and a stroke order of the input word is predicted, such that accuracy of stroke order prediction of the model may be improved.

A third loss function is the adversarial loss function (Adv Loss), which may use a discriminator structure of an auxiliary classifier generative adversarial network (ACGAN). A discriminator not only determines authenticity of a font generated, but also classifies types of the font generated. The font style label corresponding to the reference word is input while the reference word is input into the font style extraction sub-model. According to the adversarial loss function, whether the font generated matches the font style label input may be determined. Then, the model parameter of the to-be-trained font style fusion model is trained according to a matching result and the adversarial loss function, such that the model may output a font style matching the font style label.

A fourth loss function is the triplet loss function, which may be configured to constrain a 2-norm of a font style code generated by different fonts to be as close to 0 as possible. That is, the triplet loss function may obtain a 2-norm between two different font styles, and which font style obtained font style is closer to may be determined according to a value of the 2-norm. In order to make different font styles have continuity and keep the value of the 2-norm as close as possible to 0 during fusion, the font style obtained after fusion is between the two font styles and is not close to either of the font styles.

A fifth loss function is the style regularization loss function (SR loss), which may be configured to constrain sufficient distinguishability between font style codes generated by different fonts. Based on the fourth loss function, superposition of the style regularization loss function may distinguish the font style codes obtained.

The above five loss functions may be used in a superimposed or separate manner. A model parameter of a font style to be processed fusion model is corrected based on at least one loss function. Through a mutual constraint between the SR loss and the Triplet loss, style coding distributions of different fonts are finally different but as continuous as possible. Therefore, the method may continuously control the font style while generating a font.

The setting has advantages that training of the to-be-trained font style fusion model may be better constrained based on at least one loss function to obtain the target font style fusion model having an optimal effect, and when different fonts are fused based on the target font style fusion model, font style conversion of words included in the actual output image is more natural.

After at least one loss function is determined, the model may be trained based on the loss function. In this case, the second training sample set may be obtained, and the target font style fusion model may be trained based on the second training sample set.

The second training sample set includes two sets of training data. The two sets of training data are a second training word and a second training image, and a third training image and a font style label corresponding to a third training word, respectively.

A current second training sample may be a training sample to be input into the to-be-trained font style fusion model for fusion. The actual output image may be an image in which font styles are fused after training is conducted based on the to-be-trained font style fusion model. For instance, a second training sample set input includes “ [symbol] ” having a regular script style and “ [symbol] ” having a song typeface style. A second sample set is fused based on the to-be-trained font style fusion model, and the actual output image corresponding to the word “ [symbol] ” may be obtained. In this case, a font style of the word “ [symbol] ” output is between the regular script style and the song typeface style. The regular script style and the song typeface style that are used herein are existing and copyrighted font styles, which are only illustrative and not intended to limit the copyrighted font styles. The loss function may be configured to evaluate a difference between a predicted value and a real value of the model, so as to guide next training in a correct direction. The better the loss function, the better performance of the model. The theoretical output image may be a word image corresponding to a word output based on the target font style fusion model in a specific font. The loss value may be a deviation value between an actual image and a theoretical image, which is determined based on the loss function. The training target may be to use the loss value of the at least one loss function as a condition of detecting whether the loss function reaches convergence.

The second training sample set includes second training images of second training words, third training images of third training words, and font style labels of the third training words. The second training words and the third training words may have the same or different font styles. Firstly, a second training word is input into the to-be-trained font style fusion model. The second training word may include a font feature of the word, and for instance, a stroke feature. Then, a third training word and a font style label of the third training word are input. The second training sample set is trained based on the to-be-trained font style fusion model. The font feature of the second training word and a font style of the third training word are fused, and an image corresponding to the fused words is used as the actual output image.

For instance, a word “ [symbol] ” having font style A and a word “ [symbol] ” having font style B are fused based on the to-be-trained font style fusion model. A word “ [symbol] ” having font style C after fusion is used as the actual output image, and a word “ [symbol] ” having font style B is used as the theoretical output image. The font style C is a font style between the font style A and the font style B. Considering that before the to-be-trained font style fusion model is well trained, the actual output image obtained is different from the theoretical output image, and for instance, the actual output image may have stroke missing or word output errors, the actual output image obtained is not ideal. Therefore, loss processing is conducted on the actual output image and the theoretical output image based on the at least one loss function, and the loss value of the actual output image may be determined.

Whether a training error of the loss function is smaller than a preset error or an error change trend tends to be stable, or whether a current iteration number is equal to a preset number has to be determined when the loss value is determined. In response to detecting that a convergence condition is reached, and for instance, the training error of the loss function is smaller than the preset error, or the error change trend tends to be stable, training of the to-be-trained font style fusion model is completed. In this case, iterative training may be stopped. In response to detecting that the convergence condition is not reached currently, the actual output image and the corresponding theoretical output image may be obtained to further train the model until the training error of the loss function is within a preset range. When the training error of the loss function reaches the convergence condition, the to-be-trained font style fusion model that is trained completely may be used as the target font style fusion model.

According to the at least one loss function, loss processing is conducted on the actual output image and the corresponding theoretical output image, the loss values corresponding to the at least one loss function are determined, and the sum of the loss values is obtained, such that a final loss value is obtained. A deviation between the actual output image and the corresponding theoretical output image may be determined according to the obtained loss value, and then the model parameter in the to-be-trained font style fusion model may be corrected based on the loss value. When the at least one loss function reaches the convergence condition of the loss function, training of the to-be-trained font style fusion model is completed, and the target font style fusion model is obtained.

S230, the image to be processed corresponding to the word to be processed and the reference word are obtained.

S240, the image to be processed is input into the target font style fusion model.

In actual application, the target font style fusion model further includes the stroke feature extraction sub-model. The steps that the image to be processed is input into the target font style fusion model and the target word of the word to be processed in the target font style is obtained include the following step: the stroke feature of the word to be processed is extracted based on the stroke feature extraction sub-model. Accordingly, the steps that the reference font style and the image features are processed based on the encoding sub-model, and the target word of the word to be processed in the target font style is obtained include the following steps: the reference font style, the stroke feature and the image features are processed based on the encoding sub-model, and the target word of the word to be processed in the target font style is obtained.

A image to be processed corresponding to a word to be processed “ [symbol] ” is input into the target font style fusion model, and a stroke feature of the word to be processed may be extracted based on a pre-trained stroke feature extraction sub-model. Meanwhile, an image to be processed corresponding to a reference word “ [symbol] ” is input into the target font style fusion model, and a font style feature of the reference word “ [symbol] ” is extracted based on the font style extraction sub-model in the target font style fusion model. The font style feature extracted is input into the encoding sub-model, such that a font style is encoded. Then, a result obtained is input into a decoder, the font style and the above extraction result are processed in the decoder, and the target word having the target font style is obtained

S250, the stroke feature of the word to be processed is extracted based on the stroke feature extraction sub-model.

The stroke feature extraction sub-model may be a model configured to extract the stroke feature of the word, which may be a convolutional neural network (CNN), or a stroke feature extractor, is configured in the target font style fusion model, and is configured to extract the stroke feature of the word to be processed after the user inputs the word to be processed. The stroke feature of the word may include a stroke content feature of the word. For instance, a stroke feature of the word “ [symbol] ” may include a “left-falling stroke”, a “right-falling stroke”, a “horizontal turning hook”, and a “vertical curved hook”.

Similar to the font style extraction sub-model, the stroke feature extraction sub-model has to be trained before being used, and the model parameter of the model is adjusted, such that accuracy of extracting the stroke feature of the word in the image by the model is improved. After an optimal model parameter of the model is determined, stroke feature extraction is conducted on the word in the input image to be processed based on the model. The stroke feature of the word to be processed may be determined by means of the stroke feature extraction sub-model, which includes the stroke feature of the word to be processed.

S260, the image features corresponding to the word to be processed are extracted based on the image feature extraction sub-model. The image features include a content feature and a font style to be processed feature.

The content features may be a stroke feature, a stroke order feature, and a feature of a form and a structure of a Chinese word.

The image feature extraction sub-model is a pre-trained model with fixed model parameters. An image including the word to be processed is input into the model. Features such as the stroke feature, the stroke order feature, the feature of a form and a structure of a Chinese word and a font style may be determined by means of the image feature extraction sub-model. The font styles of the word to be processed and other words may be fused according to the image features of the word to be processed.

S270, the reference font style, the stroke feature and the image features are processed based on the encoding sub-model, and the target word of the word to be processed in the target font style is obtained.

The encoding sub-model may be a model capable of encoding the image features of the word. The image features of the word may be input into the encoding sub-model in a sequence format, and sequences are being spliced based on the encoding sub-model, such that the image features may be fused.

The font style feature of the reference word and the stroke feature and the image features of the word to be processed are input into the encoding sub-model for splicing, such that the reference font style and the font style of the word to be processed may be fused together to obtain the word to be processed in the target font style, and the word to be processed after processing is used as the target word.

According to the technical solution of the example of the disclosure, the reference font style of the reference word is extracted based on the font style extraction sub-model, and the feature of the reference font style is determined, such that the font style of the word to be processed is fused based on the reference font style, and the font style between the font style of the word to be processed and the reference font style is obtained. The stroke feature of the word to be processed is extracted based on the stroke feature extraction sub-model, and the stroke feature, the stroke order feature and the image features of the word to be processed are obtained. The image features corresponding to the word to be processed are extracted based on the image feature extraction sub-model, such that the determined image features corresponding to the word to be processed and the font style of the reference word are fused. The reference font style, the stroke feature and the image features are processed based on the encoding sub-model, and the target word of the word to be processed in the target font style is obtained, such that a word desired by the user is provided for the user, the obtained target word has the stroke feature and the image features of the word to be processed, and a style feature of the word is between the font style of the word to be processed and the reference font style. A problem that the font style of the target word does not match the font style expected by the user is solved, and the word having the target font style may be generated.

### EXAMPLE 3

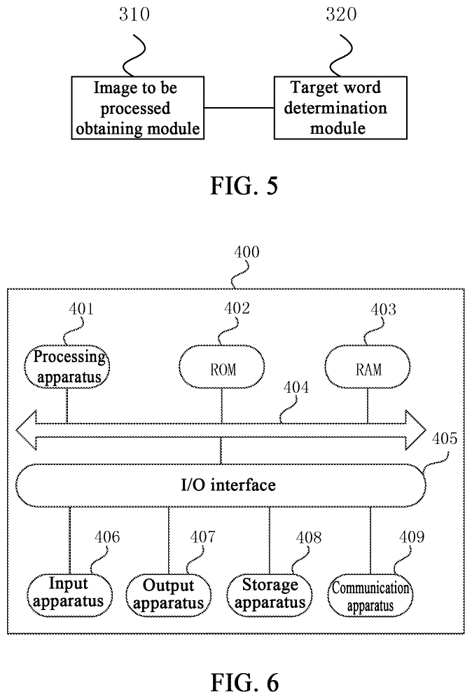

FIG. 5 is a schematic structural diagram of an apparatus for generating a word according to Example 3 of the disclosure. The apparatus includes: an image to be processed obtaining module 310 and a target word determination module 320.

The image to be processed obtaining module 310 is configured to obtain image to be processed corresponding to a word to be processed and a reference word. The target word determination module 320 is configured to input the image to be processed into a target font style fusion model, and obtain a target word of the word to be processed in a target font style. The target font style is determined based on the target font style fusion model fusing a reference font style of the reference word and a font style to be processed of the word to be processed.

According to the technical solution of the example of the disclosure, the image to be processed corresponding to the word to be processed and the reference word respectively are obtained, such that the font style to be processed and the reference font style are fused based on the target font style fusion model, and any font style between the font styles of the word to be processed and the reference word is obtained. In addition, the font styles may be repeatedly fused according to a requirement of a user until a word having a font style consistent with the requirement of the user is obtained. The image to be processed is input into the target font style fusion model, and the target word of the word to be processed in the target font style is obtained, such that a requirement of a user for converting a font style of the word to be processed into the target font style is satisfied. A problem that a word having a font style between two font styles cannot be generated is solved. The two font styles are fused into any target font style between the two font styles, and a word consistent with the target font style is generated, such that a word corresponding to any font style between the two font styles is generated.

Based on the technical solution, the image to be processed obtaining module 310 is configured to:
generate the image to be processed corresponding to the word to be processed and the reference word based on the word to be processed and the reference word that are edited in an editing control.

Based on the technical solution, the target word determination module 320 includes:
a reference font style determination sub-module configured, where the target font style fusion model includes a font style extraction sub-model, a stroke feature extraction sub-model, an image feature extraction sub-model, and an encoding sub-model, to extract the reference font style of the reference word based on the font style extraction sub-model; the image feature extraction sub-model configured to extract image features corresponding to the word to be processed based on the image feature extraction sub-model, where the image features include a content feature and a font style to be processed feature; and a target word determination sub-module configured to process the reference font style and the image features based on the encoding sub-model, and obtain the target word of the word to be processed in the target font style.

Based on the technical solution, the target word determination module 320 includes:
a stroke feature extraction sub-module configured to extract a stroke feature of the word to be processed based on the stroke feature extraction sub-model. Accordingly, the target word determination sub-module is configured to:
process the reference font style, the stroke feature and the image features based on the encoding sub-model, and obtain the target word of the word to be processed in the target font style.

Based on the technical solution, the apparatus for generating a word further includes:
a word package generation module configured to generate to-be-used words of different words in the target font style based on the target font style fusion model, and generate a word package based on the to-be-used words. Based on the technical solution, the word package generation module is further configured to:
obtain, in response to detecting that a font style selected from a font style list is the target font style and that the word to be processed is edited, the target word corresponding to the word to be processed from the word package.

Based on the technical solution, the stroke feature extraction sub-module further includes:
a stroke feature extraction sub-model determination unit configured to conduct training to obtain the stroke feature extraction sub-model in the target font style fusion model. The stroke feature extraction sub-model determination unit includes:
a first training sample set obtaining sub-unit configured to obtain a first training sample set, where the first training sample set includes a plurality of first training samples, and the first training samples include first images and first stroke vectors corresponding to first training words; and a stroke feature extraction sub-model determination sub-unit configured to use, for the plurality of first training samples, a first image of a current first training sample as an input parameter of a to-be-trained stroke feature extraction sub-model, use a corresponding first stroke vector as an output parameter of the to-be-trained stroke feature extraction sub-model, and train the to-be-trained stroke feature extraction sub-model, so as to obtain the stroke feature extraction sub-model.

Based on the technical solution, the reference font style determination sub-module includes:
a target font style fusion model determination unit configured to conduct training to obtain the target font style fusion model. The target font style fusion model determination unit includes:
a second training sample set obtaining sub-unit configured to obtain a second training sample set, where the second training sample set includes a plurality of second training samples, and the second training samples include second training images of second training words, third training images of third training words, and font style labels of the third training words; and the second training words and the third training words have the same or different font styles; an actual output image determination sub-unit configured to input, for the plurality of second training samples, a current second training sample into a to-be-trained font style fusion model, process the font style label and the third training image of the third training word based on a to-be-trained font style extraction sub-model, so as to obtain a to-be-fused font style, conduct content feature extraction on the second training image based on a to-be-trained image feature extraction sub-model, so as to obtain a to-be-fused content feature, conduct stroke feature extraction on the second training word in the second training image based on the stroke feature extraction sub-model, so as to obtain the stroke feature, and process the to-be-fused font style, the to-be-fused content feature and the stroke feature based on a to-be-trained encoding sub-model, so as to obtain an actual output image, where the to-be-trained font style fusion model includes the to-be-trained font style extraction sub-model, the to-be-trained image feature extraction sub-model, and the to-be-trained encoding sub-model; a model parameter correction sub-unit configured to conduct loss processing on the actual output image and a corresponding theoretical output image based on at least one loss function, determine a loss value, and correct at least one model parameter in the to-be-trained font style fusion model based on the loss value; and a target font style fusion model determination sub-unit configured to set convergence of the at least one loss function as a training target, and obtain the target font style fusion model.

Based on the technical solution, the at least one loss function includes a reconstruction loss function, a stroke order loss function, an adversarial loss function, a triplet loss function, and a style regularization loss function.

The apparatus for generating a word according to the example of the disclosure may execute the method for generating a word according to any one of the examples of the disclosure, and has corresponding functional modules and effects corresponding to execution of the method.

A plurality of units and modules included in the apparatus are merely divided according to a functional logic, but are not limited to the above division, as long as the corresponding functions may be achieved. In addition, names of a plurality of functional units are merely for convenience of mutual distinguishing, and are not used to limit the protective scope of the example of the disclosure.

### EXAMPLE 4

FIG. 6 is a schematic structural diagram of an electronic device according to Example 4 of the disclosure. FIG. 6 shows a schematic structural diagram of an electronic device (for instance, a terminal device or a server in FIG. 6) 400 suitable for implementing an example of the disclosure below. The terminal device in the example of the disclosure may be, but is not limited to, a mobile terminal such as a mobile phone, a notebook computer, a digital broadcast receiver, a personal digital assistant (PDA), a portable android device (PAD), a portable media player (PMP), or a vehicle-mounted terminal (for instance, a vehicle-mounted navigation terminal), and a fixed terminal such as a digital television (TV) or a desktop computer. The electronic device 400 shown in FIG. 6 is only illustrative, and is not intended to limit functions and a use scope of the example of the disclosure.

As shown in FIG. 6, the electronic device 400 may include a processing apparatus (for instance, a central processing unit or a graphics processing unit) 401, which may execute various appropriate actions and processing according to a program stored in a read-only memory (ROM) 402 or a program loaded from a storage apparatus 406 to a random access memory (RAM) 403. The RAM 403 further stores various programs and data required for operations of the electronic device 400. The processing apparatus 401, the ROM 402 and the RAM 403 are connected to one another by means of a bus 404. An input/output (I/O) interface 405 is further connected to the bus 404.

Generally, the following apparatuses may be connected to the I/O interface 405: an input apparatus 406 including, for instance, a touch screen, a touch pad, a keyboard, a mouse, a camera, a microphone, an accelerometer, a gyroscope, etc.; an output apparatus 407 including, for instance, a liquid crystal display (LCD), a speaker, a vibrator, etc.; the storage apparatus 406 including, for instance, a magnetic tape, a hard disk, etc.; and a communication apparatus 409. The communication apparatus 409 may allow the electronic device 400 to be in wireless or wired communication with other devices so as to achieve data exchange. Although FIG. 6 shows the electronic device 400 including various apparatuses, not all the apparatuses shown are required to be implemented or included. More or fewer apparatuses may be alternatively implemented or included.

According to the example of the disclosure, the process described above with reference to the flow diagram may be implemented to be a computer software program. For instance, an example of the disclosure includes a computer program product, which includes a computer program hosted by a non-transitory computer-readable medium. The computer program includes a program code configured to execute the method shown in the flow diagram. In such an example, the computer program may be downloaded and configured from a network through the communication apparatus 409, or configured from the storage apparatus 406, or configured from the ROM 402. The computer program executes the functions defined in the method for generating a word according to the example of the disclosure when being executed by the processing apparatus 401.

### EXAMPLE 5

Example 5 of the disclosure provides a computer storage medium, which stores a computer program. The computer program implements the method for generating a word according to the example when being executed by a processor.

The computer-readable medium described in the disclosure may be a computer-readable signal medium, or a computer-readable storage medium, or any combination thereof. For instance, the computer-readable storage medium may be, but is not limited to, an electronic, magnetic, optical, electromagnetic, infrared, or semiconductor system, apparatus, or device, or any suitable combination thereof. Instances of the computer-readable storage medium may include, but are not limited to, an electrical connection with one or more wires, a portable computer disk, a hard disk, RAM, ROM, an erasable programmable read-only memory (EPROM), a flash memory, an optical fiber, a compact disc read-only memory (CD-ROM), an optical storage device, a magnetic storage device, or any suitable combination thereof. In the disclosure, the computer-readable storage medium may be any tangible medium including or storing a program. The program may be used by or in combination with an instruction execution system, apparatus or device. In the disclosure, the computer-readable signal medium may include a data signal in a baseband or as part of a carrier for transmission, and the data signal carries a computer-readable program code. The transmitted data signal may be in various forms, which may be, but is not limited to, an electromagnetic signal, an optical signal, or any suitable combination thereof. The computer-readable signal medium may further be any computer-readable medium other than the computer-readable storage medium. The computer-readable signal medium may transmit, propagate or transmit a program used by or in combination with an instruction execution system, apparatus or device. The program code included in the computer-readable medium may be transmitted by any suitable medium, including but not limited to an electric wire, an optical cable, radio frequency (RF), etc., or any suitable combination thereof.

In some embodiments, a client and a server may be in communication with each other with any currently known or future-developed network protocol, for instance, a hypertext transfers protocol (HTTP), and may be interconnected with digital data communication (for instance, a communication network) in any form or medium. Instances of the communication network include a local area network (LAN), a wide area network (WAN), the internet work (for instance, the Internet), an end-to-end network (for instance, an ad hoc end-to-end network), and any currently-known or future-developed networks.

The computer-readable medium may be included in the electronic device, or may exist independently without being assembled into the electronic device.

The computer-readable medium carries one or more programs. When the one or more programs are executed by the electronic device, the electronic device obtains image to be processed corresponding to a word to be processed and a reference word respectively; and inputs the image to be processed into a target font style fusion model, and obtains a target word of the word to be processed in a target font style. The target font style is determined based on the font style fusion model fusing a reference font style of the reference word and a font style to be processed of the word to be processed.

Alternatively, the computer-readable medium carries one or more programs. When the one or more programs are executed by the electronic device, the electronic device obtains image to be processed corresponding to a word to be processed and a reference word; and inputs the image to be processed into a target font style fusion model, and obtains a target word of the word to be processed in a target font style. The target font style is determined based on the target font style fusion model fusing a reference font style of the reference word and a font style to be processed of the word to be processed.

A computer program code configured to execute an operation of the disclosure may be written in one or more programming languages or a combination thereof. The programming languages include, but are not limited to, object-oriented programming languages such as Java, Smalltalk, and C++, and further include conventional procedural programming languages such as “C” or similar programming languages. The program code may be executed entirely on a user computer, executed partially on a user computer, executed as a stand-alone software package, executed partially on a user computer and partially on a remote computer, or executed entirely on the remote computer or a server. In the case involving the remote computer, the remote computer may be connected to the user computer through any type of networks including the LAN or the WAN, or may be connected to an external computer (for instance, the remote computer is connected through the Internet by an Internet service provider).

The flow diagrams and block diagrams in the accompanying drawings illustrate system structures, functions and operations, which may be achieved according to systems, methods and computer program products in all the examples of the disclosure. In view of that, each block in the flow diagrams or block diagrams may represent a module, a program segment, or part of a code, which includes one or more executable instructions configured to implement specified logic functions. It should further be noted that in some alternative implementations, the functions noted in the blocks may also occur in an order different from that in the accompanying drawings. For instance, the functions represented by two continuous blocks may be actually implemented basically in parallel, or may be implemented in reverse orders, which depends on the involved functions. It should further be noted that each block in the block diagrams and/or flow diagrams and combinations of the blocks in the block diagrams and/or the flow diagrams may be implemented with dedicated hardware-based systems that implement the specified functions or operations, or may be implemented with combinations of dedicated hardware and computer instructions.

The units involved in the examples described in the disclosure may be implemented by software or hardware. Names of the units do not limit the units themselves in a case. For instance, a first obtaining unit may also be described as “a unit obtaining at least two Internet protocol addresses”.

The functions described herein may be at least partially executed by one or more hardware logic components. For instance, for the non-limitative purposes, illustrative types of hardware logic components that may be used include: a field programmable gate array (FPGA), an application specific integrated circuit (ASIC), an application specific standard part (ASSP), a system on chip (SOC), a complex programming logic device (CPLD), etc.

In the context of the disclosure, the machine-readable medium may be a tangible medium, which may include or store a program used by or used in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. Instances of the machine-readable storage medium may include an electrical connection based on one or more wires, a portable computer disk, a hard disk, RAM, ROM, EPROM or a flash memory, an optical fiber, CD-ROM, an optical storage device, a magnetic storage device, or any suitable combination thereof.

According to one or more examples of the disclosure, [Instance 1] provides a method for generating a word. The method includes:
image to be processed corresponding to a word to be processed and a reference word are obtained respectively; and
the image to be processed is input into a target font style fusion model, and a target word of the word to be processed in a target font style is obtained.

The target font style is determined based on the target font style fusion model fusing a reference font style of the reference word and a font style to be processed of the word to be processed.

According to one or more examples of the disclosure, [Instance 2] provides a method for processing an image, further comprising:
the step that the image to be processed corresponding to the word to be processed and the reference word are obtained includes:
the image to be processed corresponding to the word to be processed and the reference word are generated based on the word to be processed and the reference word that are edited in an editing control.

According to one or more examples of the disclosure, [Instance 3] provides a method for generating a word. In the method further includes:
the target font style fusion model includes a font style extraction sub-model, an image feature extraction sub-model, and an encoding sub-model. The steps that the image to be processed is input into the target font style fusion model, and the target word of the word to be processed in the target font style is obtained further include the following steps:
the reference font style of the reference word is extracted based on the font style extraction sub-model;
image features corresponding to the word to be processed are extracted based on the image feature extraction sub-model, where the image features include a content feature and a font style to be processed feature; and
the reference font style and the image features are processed based on the encoding sub-model, and the target word of the word to be processed in the target font style is obtained.

According to one or more examples of the disclosure, [Instance 4] provides a method for generating a word. In the method,
the target font style fusion model further includes a stroke feature extraction sub-model. The steps that the image to be processed is input into the target font style fusion model, and the target word of the word to be processed in the target font style is obtained include the following step:
a stroke feature of the word to be processed is extracted based on the stroke feature extraction sub-model.

The steps that the reference font style and the image features are processed based on the encoding sub-model, and the target word of the word to be processed in the target font style is obtained include the following steps:
the reference font style, the stroke feature and the image features are processed based on the encoding sub-model, and the target word of the word to be processed in the target font style is obtained.

According to one or more examples of the disclosure, [Instance 5] provides a method for generating a word. The method further includes the following steps:
to-be-used words of different words in the target font style are generated based on the target font style fusion model, and a word package is generated based on the to-be-used words.

According to one or more examples of the disclosure, [Instance 6] provides a method for generating a word. The method further includes:
in response to detecting that a font style selected from a font style list is the target font style and that the word to be processed is edited, the target word corresponding to the word to be processed is obtained from the word package.

According to one or more examples of the disclosure, [Instance 7] provides a method for generating a word. The method further includes t:
training is conducted to obtain the stroke feature extraction sub-model in the target font style fusion model.

The step that training is conducted to obtain the stroke feature extraction sub-model in the target font style fusion model includes the following steps:
a first training sample set is obtained, where the first training sample set includes a plurality of first training samples, and the first training samples include first images and first stroke vectors corresponding to first training words; and
for the plurality of first training samples, a first image of a current first training sample is used as an input parameter of a to-be-trained stroke feature extraction sub-model, a corresponding first stroke vector is used as an output parameter of the to-be-trained stroke feature extraction sub-model, and the to-be-trained stroke feature extraction sub-model is trained, so as to obtain the stroke feature extraction sub-model.

According to one or more examples of the disclosure, [Instance 8] provides a method for generating a word. The method further includes:
training is conducted to obtain the target font style fusion model.

The step that training is conducted to obtain the target font style fusion model includes:
a second training sample set is obtained, where the second training sample set includes a plurality of second training samples, and the second training samples include second training images of second training words, third training images of third training words, and font style labels of the third training words; and the second training words and the third training words have the same or different font styles;
for the plurality of second training samples, a current second training sample is input into a to-be-trained font style fusion model, the font style label and the third training image of the third training word are processed based on a to-be-trained font style extraction sub-model, so as to obtain a to-be-fused font style, content feature extraction is conducted on the second training image based on a to-be-trained image feature extraction sub-model, so as to obtain a to-be-fused content feature, stroke feature extraction is conducted on the second training word in the second training image based on the stroke feature extraction sub-model, so as to obtain the stroke feature, and the to-be-fused font style, the to-be-fused content feature and the stroke feature are processed based on a to-be-trained encoding sub-model, so as to obtain an actual output image, where the to-be-trained font style fusion model includes the to-be-trained font style extraction sub-model, the to-be-trained image feature extraction sub-model, and the to-be-trained encoding sub-model;
loss processing is conducted on the actual output image and a corresponding theoretical output image based on at least one loss function, a loss value is determined, and at least one model parameter in the to-be-trained font style fusion model is corrected based on the loss value; and
convergence of the at least one loss function is set as a training target, and the target font style fusion model is obtained.

According to one or more examples of the disclosure, [Instance 9] provides a method for generating a word. The method further includes:
the at least one loss function includes a reconstruction loss function, a stroke order loss function, an adversarial loss function, a triplet loss function, and a style regularization loss function.

According to one or more examples of the disclosure, [Instance 10] provides an apparatus for generating a word. The apparatus includes:
an image to be processed obtaining module configured to obtain image to be processed corresponding to a word to be processed and a reference word; and
a target word determination module configured to input the image to be processed into a target font style fusion model, and obtain a target word of the word to be processed in a target font style.

The target font style is determined based on the target font style fusion model fusing a reference font style of the reference word and a font style to be processed of the word to be processed.

Further, although a plurality of operations is depicted in a particular order, it should be understood that the operations are not required to be executed in the particular order shown or in a sequential order. In some cases, multitasking and parallel processing may be advantageous. Likewise, although a plurality of implementation details is included in the above discussion, the details should not be construed as limiting the scope of the disclosure. Some features described in the context of separate examples may also be implemented in combination in a single example. On the contrary, various features described in the context of a single example may also be implemented in a plurality of examples independently or in any suitable sub-combination way.

1. A method for generating a word, comprising:
obtaining images to be processed corresponding to a word to be processed and a reference word respectively; and
inputting the images to be processed into a target font style fusion model to obtain a target word of the word to be processed in a target font style, wherein
the target font style is determined based on the target font style fusion model fusing a reference font style of the reference word and a font style to be processed of the word to be processed.

2. The method of claim 1, wherein obtaining images to be processed corresponding to a word to be processed and a reference word comprises:
generating the images to be processed corresponding to the word to be processed and the reference word respectively based on the word to be processed and the reference word that are edited in an editing control.

3. The method of claim 1, wherein the target font style fusion model comprises a font style extraction sub-model, an image feature extraction sub-model, and an encoding sub-model, and inputting the images to be processed into a target font style fusion model to obtain a target word of the word to be processed in a target font style comprises:
extracting the reference font style of the reference word based on the font style extraction sub-model;
extracting image features corresponding to the word to be processed based on the image feature extraction sub-model, wherein the image features comprise a content feature and a font style feature to be processed; and
obtaining the target word of the word to be processed in the target font style based on the encoding sub-model processing the reference font style and the image features.

4. The method of claim 3, wherein the target font style fusion model further comprises a stroke feature extraction sub-model; and inputting the images to be processed into a target font style fusion model to obtain a target word of the word to be processed in a target font style comprises:
extracting a stroke feature of the word to be processed based on the stroke feature extraction sub-model; and
wherein the obtaining the target word of the word to be processed in the target font style based on the encoding sub-model processing the reference font style and the image features comprises:
obtaining the target word of the word to be processed in the target font style based on the encoding sub-model processing the reference font style, the stroke feature and the image features.

5. The method of claim 1, further comprising:
generating words to be used for different words in the target font style based on the target font style fusion model, and generating a word package based on the words to be used.

6. The method of claim 5, further comprising:
obtaining, in response to detecting that a font style selected from a font style list is the target font style and that the word to be processed is edited, the target word corresponding to the word to be processed from the word package.

7. The method of claim 4, further comprising:
obtaining the stroke feature extraction sub-model in the target font style fusion model by training,
wherein obtaining the stroke feature extraction sub-model in the target font style fusion model by training comprises:
obtaining a first training sample set, wherein the first training sample set comprises a plurality of first training samples, and the first training sample comprises a first image and a first stroke vector corresponding to a first training word; and
using, for the plurality of first training samples, a first image of a current first training sample as an input parameter of a stroke feature extraction sub-model to be trained, using a corresponding first stroke vector as an output parameter of the stroke feature extraction sub-model to be trained to train the stroke feature extraction sub-model to be trained to obtain the stroke feature extraction sub-model.

8. The method of claim 7, further comprising:
obtaining the target font style fusion model by training,
wherein obtaining the target font style fusion model by training comprises:
obtaining a second training sample set, wherein the second training sample set comprises a plurality of second training samples, and the second training sample comprises a second training image of a second training word, a third training image of a third training word, and a font style label of the third training word, and wherein the second training word and the third training word have the same or different font styles;
inputting, for the plurality of second training samples, a current second training sample into a font style fusion model to be trained to:
obtain a font style to be fused based on the font style extraction sub-model to be trained processing the font style label and the third training image of the third training word;
obtain the content feature to be fused based on the image feature extraction sub-model to be trained performing content feature extraction on the second training image,
obtain the stroke feature based on the stroke feature extraction sub-model performing stroke feature extraction on the second training word in the second training image, and
obtain an actual output image based on an encoding sub-model to be trained processing the font style to be fused, the content feature to be fused and the stroke feature, wherein the font style fusion model to be trained comprises the font style extraction sub-model to be trained, the image feature extraction sub-model to be trained, and the encoding sub-model to be trained;
performing, based on at least one loss function, loss processing on the actual output image and a corresponding theoretical output image to determine a loss value to correct at least one model parameter in the font style fusion model to be trained based on the loss value; and
setting convergence of the at least one loss function as a training target to obtain the target font style fusion model.

9. The method of claim 8, wherein the at least one loss function comprises a reconstruction loss function, a stroke order loss function, an adversarial loss function, a style encoding loss function, and a style regularization loss function.

10. (canceled)

11. An electronic device, comprising:
at least one processor; and
a memory configured to store at least one program, wherein
when the at least one program is executed by the at least one processor, the at least one processor is caused to implement the method, comprising:
obtaining images to be processed corresponding to a word to be processed and a reference word respectively; and
inputting the images to be processed into a target font style fusion model to obtain a target word of the word to be processed in a target font style, wherein
the target font style is determined based on the target font style fusion model fusing a reference font style of the reference word and a font style to be processed of the word to be processed.

12. A storage medium comprising a computer-executable instruction, wherein the computer-executable instruction, when being executed by a processor of a computer, is configured to execute the method comprising:
obtaining images to be processed corresponding to a word to be processed and a reference word respectively; and
inputting the images to be processed into a target font style fusion model to obtain a target word of the word to be processed in a target font style, wherein
the target font style is determined based on the target font style fusion model fusing a reference font style of the reference word and a font style to be processed of the word to be processed.

13. The method of claim 1, including a computer program product, comprising a computer program stored in a non-transitory computer-readable medium, wherein the computer program comprises a program code configured to execute the method comprising:
obtaining images to be processed corresponding to a word to be processed and a reference word respectively; and
inputting the images to be processed into a target font style fusion model to obtain a target word of the word to be processed in a target font style, wherein
the target font style is determined based on the target font style fusion model fusing a reference font style of the reference word and a font style to be processed of the word to be processed.

14. The electronic device of claim 11, wherein obtaining images to be processed corresponding to a word to be processed and a reference word comprises:
generating the images to be processed corresponding to the word to be processed and the reference word respectively based on the word to be processed and the reference word that are edited in an editing control.

15. The electronic device of claim 11, wherein the target font style fusion model comprises a font style extraction sub-model, an image feature extraction sub-model, and an encoding sub-model, and inputting the images to be processed into a target font style fusion model to obtain a target word of the word to be processed in a target font style comprises:
extracting the reference font style of the reference word based on the font style extraction sub-model;
extracting image features corresponding to the word to be processed based on the image feature extraction sub-model, wherein the image features comprise a content feature and a font style feature to be processed; and
obtaining the target word of the word to be processed in the target font style based on the encoding sub-model processing the reference font style and the image features.

16. The electronic device of claim 15, wherein the target font style fusion model further comprises a stroke feature extraction sub-model; and inputting the images to be processed into a target font style fusion model to obtain a target word of the word to be processed in a target font style comprises:
extracting a stroke feature of the word to be processed based on the stroke feature extraction sub-model; and
wherein the obtaining the target word of the word to be processed in the target font style based on the encoding sub-model processing the reference font style and the image features comprises:
obtaining the target word of the word to be processed in the target font style based on the encoding sub-model processing the reference font style, the stroke feature and the image features.

17. The electronic device of claim 11, further comprising:
generating words to be used for different words in the target font style based on the target font style fusion model, and generating a word package based on the words to be used.

18. The electronic device of claim 17, further comprising:
obtaining, in response to detecting that a font style selected from a font style list is the target font style and that the word to be processed is edited, the target word corresponding to the word to be processed from the word package.

19. The electronic device of claim 18, further comprising:
obtaining the stroke feature extraction sub-model in the target font style fusion model by training,
wherein obtaining the stroke feature extraction sub-model in the target font style fusion model by training comprises:
obtaining a first training sample set, wherein the first training sample set comprises a plurality of first training samples, and the first training sample comprises a first image and a first stroke vector corresponding to a first training word; and
using, for the plurality of first training samples, a first image of a current first training sample as an input parameter of a stroke feature extraction sub-model to be trained, using a corresponding first stroke vector as an output parameter of the stroke feature extraction sub-model to be trained to train the stroke feature extraction sub-model to be trained to obtain the stroke feature extraction sub-model.

20. The electronic device of claim 19, further comprising:
obtaining the target font style fusion model by training,
wherein obtaining the target font style fusion model by training comprises:
obtaining a second training sample set, wherein the second training sample set comprises a plurality of second training samples, and the second training sample comprises a second training image of a second training word, a third training image of a third training word, and a font style label of the third training word, and wherein the second training word and the third training word have the same or different font styles;
inputting, for the plurality of second training samples, a current second training sample into a font style fusion model to be trained to:
obtain a font style to be fused based on the font style extraction sub-model to be trained processing the font style label and the third training image of the third training word;
obtain the content feature to be fused based on the image feature extraction sub-model to be trained performing content feature extraction on the second training image,
obtain the stroke feature based on the stroke feature extraction sub-model performing stroke feature extraction on the second training word in the second training image, and
obtain an actual output image based on an encoding sub-model to be trained processing the font style to be fused, the content feature to be fused and the stroke feature, wherein the font style fusion model to be trained comprises the font style extraction sub-model to be trained, the image feature extraction sub-model to be trained, and the encoding sub-model to be trained;
performing, based on at least one loss function, loss processing on the actual output image and a corresponding theoretical output image to determine a loss value to correct at least one model parameter in the font style fusion model to be trained based on the loss value; and
setting convergence of the at least one loss function as a training target to obtain the target font style fusion model.

21. The electronic device of claim 20, wherein the at least one loss function comprises a reconstruction loss function, a stroke order loss function, an adversarial loss function, a style encoding loss function, and a style regularization loss function.
